(19) United States
(12) Patent Application Publication
(10) Pub. No.: US 2006/0120256 A1
(43) Pub. Date: Jun. 8, 2006

(54) Optical information recording carrier

(75) Inventors: Seiji Nishino, Osaka-shi (JP); Teruhiro Shiono, Osaka-shi (JP); Hiroaki Yamamoto, Kawabe-gun (JP); Tatsuo Ito, Osaka-shi (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD, Kadoma-shi (JP)

(21) Appl. No.: 10/539,666

(22) PCT Filed: Feb. 25, 2004
(86) PCT No.: PCT/JP04/02165

§ 371 Date: Jun. 14, 2005

(30) Foreign Application Priority Data
Feb. 25, 2003 (JP) 2003-047299

(51) Int. Cl. G11B 7/24

(52) U.S. Cl. 369/275.1

(57) ABSTRACT

An optical information recording carrier comprising a substrate and at least one recording film arranged on the substrate is disclosed. Information is recorded on the recording film through irradiation with a recording light having a predetermined wavelength (λ). The recording film is composed of a heat generating layer and at least one dielectric layer arranged in contact with the heat generating layer. The heat generating layer and the dielectric layer are substantially transparent to the recording light with wavelength (λ), and are respectively formed to have a predetermined thickness and a predetermined refractive index so that the field intensity of the recording light becomes maximum at the interface between the heat generating layer and the dielectric layer.

### TECHNICAL FIELD

The present invention relates to an optical information recording carrier with which information is optically recorded and reproduced.

### BACKGROUND ART

The steadily rising quantity of information being processed in recent years has required optical information recording carriers (disk carriers) of larger capacity, and great advances have been made in terms of increasing recording density.

The recording density of an optical information recording carrier is proportional to (NA/λ)² (where λ is the recording light wavelength and NA is the numerical aperture of the objective lens). In view of this, a technique has been proposed recently for attaining a recording density of 25 Gbytes that is approximately six times that of a DVD disk, with a five-inch-diameter optical disk, using a GaN laser with a wavelength of 405 nm and an objective lens with a numerical aperture of 0.85.

However, this approach of increasing recording density by raising the numerical aperture of an objective lens as high as possible, or by making the recording light source wavelength as short as possible, is beginning to reach its limits.

If the wavelength of the light source is shorter than 405 nm, there is a sharp decrease in the optical transmissivity of the polycarbonate substrate that generally is used as the resin substrate of an optical information recording carrier. Further, if the wavelength of the light source is shorter than 400 nm, along with a decrease in the optical transmissivity of the resin substrate of the optical information recording carrier, the resin components decompose when irradiated for an extended period, further decreasing the optical transmissivity of the resin substrate.

Meanwhile, if the numerical aperture of the objective lens is increased more than this, it then will be necessary to reduce the distance (WD) between the objective lens and the optical information recording carrier. Consequently, because of the WD limitations and the tilt margin of the optical information recording carrier, the thickness of the protective layer formed over the recording film can end up being less than 100 μm. Since the WD thus decreases when the numerical aperture of the objective lens is increased more than this, the objective lens tends to collide with the optical information recording carrier. Furthermore, a thinner protective layer means that any dirt on the surface of the protective layer provided to the optical information recording carrier will be extremely close to the signal surface of the recording film, so just a small amount of dirt on the protective layer side of the optical information recording carrier can lead to degradation of the information reproduction signal.

This approach of achieving higher density merely by shortening the wavelength of the recording light and increasing the numerical aperture of the objective lens creates other basic problems (such as degradation of the reproduction signal and insufficient light due to a decrease in optical transmissivity).

In view of this, employing multiple recording films will be an important way further to increase the density of an optical information recording carrier in the future. FIG. 5 is a cross section of a conventional optical information recording carrier provided with a plurality of recording films (hereinafter referred to as a multi-layer information recording carrier). This multi-layer information recording carrier comprises three layers of semitransparent recording film 101 formed over a substrate 104, and a protective layer 102 provided as the uppermost layer. Recording film separating layers 103 are provided between the adjacent semitransparent recording films 101. The example shown here is one in which light is irradiated on this multi-layer information recording carrier from the side of the protective layer 102. Therefore, an objective lens 105 is disposed on the side of this multi-layer information recording carrier where the protective layer 102 is provided. The focal area 107 of the luminous flux 106 produced by this objective lens 105 is formed over the targeted recording film 101, and information is recorded on this targeted recording film 101.

The semitransparent recording films used in this conventional multi-layer information recording carrier generate heat by absorbing recording light, and the phase transition or deformation occurring in the recording material due to this heat is utilized to record signals on the recording films. Therefore, the recording films are formed so as to be semitransparent to the recording light and to absorb the recording light. Since the recording light is thus absorbed directly by the recording films with the conventional structure described above, the light is attenuated greatly when the total number of laminated recording films reaches four or more layers, making it difficult to record information on the recording films disposed the farthest away from the multi-layer information recording carrier surface on the objective lens side, so the recording capacity was limited.

Recording information by utilizing a multiple photon absorption phenomenon (hereinafter referred to as multiple photon absorption recording) has been drawing considerable attention in recent years as a way to overcome this problem (see JP H8-220688A, for example). In this specification, multiple photon absorption recording is recording based on a principal explained hereinafter.

A feature of multiple photon absorption recording is that a recording material that is transparent at the wavelength of the recording light is used to form the recording film. In conventional recording that utilizes light absorption, light is absorbed by a semitransparent recording film and heat is generated, but in the case of multiple photon absorption recording, an optical absorption reaction is induced by the excitation of the electrons in the recording material by multiple photons in the focal area of the recording light (the recording light focal point and its surroundings), which is the area where the electrical field intensity of the light is extremely high. Moreover, optical absorption by the recording material does not occur outside of the focal area in multiple photon absorption recording. Thus, with multiple photon absorption recording, since the recording films are transparent to the recording light, the problem of attenuation of the light by light passing through the recording films as with a multi-layer information recording carrier having semitransparent recording films does not occur. This means that more recording films can be laminated.

FIG. 6 shows how information is recorded on an optical information recording carrier that allows multiple photon absorption recording. In this example, a recording layer 111 composed of a recording material that is transparent to the recording light is disposed between a substrate 113 and a protective layer 112. A row of signal portions 114 is recorded in substantially the same plane of the recording layer 111, and a plurality of such recording planes are provided within the recording layer 111 to accomplish the three-dimensional recording of information. Put another way, multiple layers of recording planes can be provided. An objective lens 115 is disposed on the side of this optical information recording carrier where the protective layer 112 is provided, and the recording light is incident on the optical information recording carrier from the side of the protective layer 112. The luminous flux 116 focused by the objective lens 115 forms a focal area 117 at the desired location of the recording layer 111. The recording layer 111 absorbs light in this focal area 117, forming a signal portion 114.

When quartz glass is used for the recording material, for example, the amount of recording light needed for multiple photon absorption recording corresponds to a peak laser output of 1.33 MW in 120 femtoseconds (see, for example, “Three-dimensional Optical Data Storage in Vitreous Silica,” Watanabe, Misawa, et al., JJAP, Vol. 37 (1998), pp. L1527-L1530). Therefore, recording is only possible with a titanium sapphire laser in this case.

Inorganic materials have been used commonly in the past as recording materials in multiple photon absorption recording. The reasons for this include that many inorganic materials have relatively high sensitivity to multiple photon absorption recording, and the ease of producing a transparent film such as a metal oxide, nitride, or sulfide film.

Nevertheless, since inorganic materials have high thermal conductivity, when a recording film is formed from an inorganic material, the heat generated by the absorption of light in the focal area is diffused, which is a problem in that it inhibits a temperature rise in the focal area and hampers an increase in recording sensitivity.

Other problems with inorganic materials are that their deformation hardness and melting point are both higher than those of metal compounds used in optical absorption recording as shown in FIG. 4, so even though multiple photon absorption results in heat being generated in the recording film, there tends to be no change in the recording film, and this also explains why the recording sensitivity of a recording film composed of an inorganic material tends to remain low.

This is readily apparent from the following comparison. The melting temperature of tellurium metal compounds (such as Te₆₀Ge₂₀Sb₁₀) that are currently often used as recording materials for semitransparent recording films is about 230° C. On the other hand, the melting temperature of tellurium oxide containing 20 mol % Na₂CO₃ (20 mol Na₂CO₃-80 mol TeO₂), for example, in a tellurium oxide compound of inorganic glass, which has relatively high sensitivity as a multiple photon absorption recording material, is about 500° C., meaning that it is higher than the melting point of a tellurium metal compound. In this respect, multiple photon absorption recording in which an inorganic material is used as the recording material affords lower sensitivity than a conventional recording method involving the absorption of light by a semitransparent recording film.

Another problem with multiple photon absorption recording is that unlike recording involving the absorption of light by a semitransparent recording film, the recording is not performed merely by using the heat generated by the absorption of light, so sensitivity is poor. The optical output is inadequate with the semiconductor lasers generally used as optical disk recording light sources, and it has been impossible to perform multiple photon recording using a semiconductor laser. Therefore, when multiple photon absorption recording was performed, a high-output laser such as a YAG laser had to be used for the recording light source.

As mentioned above, when quartz glass is used as the recording material, for example, a peak laser output of 1.33 MW in 120 femtoseconds is required, so recording is only possible with a titanium sapphire laser, which makes this method virtually impractical for civilian applications.

In summary, the poor sensitivity of multiple photon absorption recording seems to arise from the following two problems.

The first problem is that the heat generation efficiency of multiple photon absorption is inferior to that of conventional light absorption.

The second problem is that since the recording film needs to be transparent (e.g., at least about 85%, excluding Fresnel reflection), a metal oxide, metal sulfide, or the like ends up being used, the thermal deformation temperature is higher than that of metal films and other such semitransparent recording films, the recording film is very hard and resistant to deformation, and the thermal conductivity of the recording film is so high that the proportional increase in temperature is small. Various experiments have been conducted into using organic resin materials, which have a lower melting point and are easier to deform, as recording materials in an effort to solve the above problems, but even when polycarbonate, which is widely used as a resin substrate material, was used as a recording film, the required peak laser output was 0.2 MW, and efforts failed to raise recording sensitivity to a level at which the use of a semiconductor laser would become feasible.

### DISCLOSURE OF INVENTION

An optical information recording carrier according to the present invention comprises a substrate and at least one recording film provided over the substrate, with which information is recorded on the recording film by irradiation with recording light having a predetermined wavelength λ, wherein the recording film comprises a heat-generating layer and at least one dielectric layer provided in contact with the heat-generating layer, and the heat-generating layer and the dielectric layer are substantially transparent with respect to light of the wavelength λ, and have a predetermined thickness and a predetermined refractive index with which the electrical field intensity of the recording light is at its maximum at the interface between the heat-generating layer and the dielectric layer. “Substantially transparent” as used in this specification means that the optical transmissivity is at least 90%, and preferably at least 95%.

With the optical information recording carrier of the present invention, the dielectric layer may be provided in contact with the heat-generating layer on both sides of the heat-generating layer.

With the optical information recording carrier of the present invention, if λ1 is the wavelength of the recording light within the heat-generating layer, the thickness of the heat-generating layer is preferably (n1×λ1)/2, where n1 is an integer of at least 1.

With the optical information recording carrier of the present invention, if λ2 is the wavelength of the recording light within the dielectric layer, the thickness of the dielectric layer is preferably (n2×λ2)/2, where n2 is an integer of at least 1.

With the optical information recording carrier of the present invention, a plurality of recording films may be provided, and a recording film separating layer that is substantially transparent with respect to light of the wavelength λ may be disposed between adjacent recording films.

With the optical information recording carrier of the present invention, the heat-generating layer may contain at least one compound selected from among tellurium oxide, lithium niobate, zinc oxide, titanium oxide, and bismuth oxide.

With the optical information recording carrier of the present invention, the dielectric layer may be formed from a resin, may contain at least one compound selected from among silicon dioxide, magnesium fluoride, calcium fluoride, indium oxide, and tin oxide, and may be formed from a thermoplastic material.

With the optical information recording carrier of the present invention, the heat-generating layer preferably generates heat by absorbing multiple photons near its interface with the dielectric layer.

With the optical information recording carrier of the present invention, the heat-generating layer and the dielectric layer may be formed from materials with mutually different coefficients of thermal expansion. If so, the strain produced by the difference between the coefficients of thermal expansion of the heat-generating layer and the dielectric layer can be utilized in recording signal formation.

### BRIEF DESCRIPTION OF DRAWINGS

FIG. 1 is a cross section illustrating an embodiment of the optical information recording carrier of the present invention.

FIG. 2 is an enlarged cross section of an example of the recording film of the optical information recording carrier shown in FIG. 1, and is a diagram of the distribution of electrical field intensity of light in this film structure.

FIG. 3 is an enlarged cross section of another example of the recording film of the optical information recording carrier shown in FIG. 1, and is a diagram of the distribution of electrical field intensity of light in this film structure.

FIG. 4 is an enlarged cross section of yet another example of the recording film of the optical information recording carrier shown in FIG. 1, and is a diagram of the distribution of electrical field intensity of light in this film structure.

FIG. 5 is a cross section illustrating a conventional optical information recording carrier in which a plurality of semitransparent recording films are laminated.

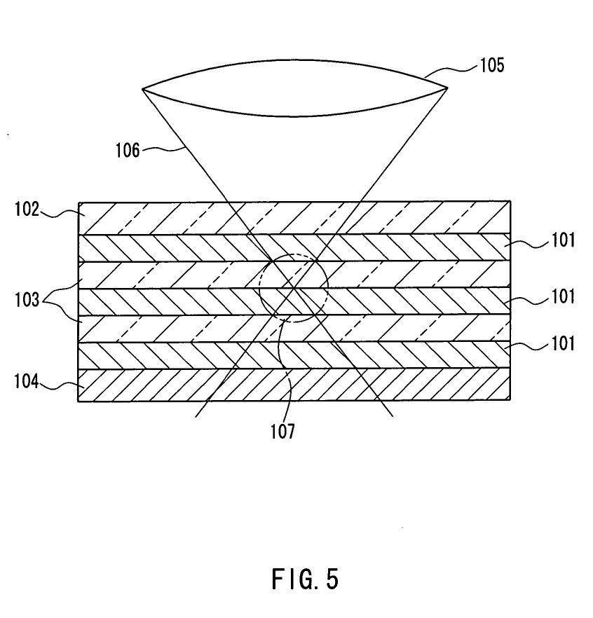

FIG. 6 is a cross section illustrating a conventional optical information recording carrier with which multiple photon absorption recording is possible.

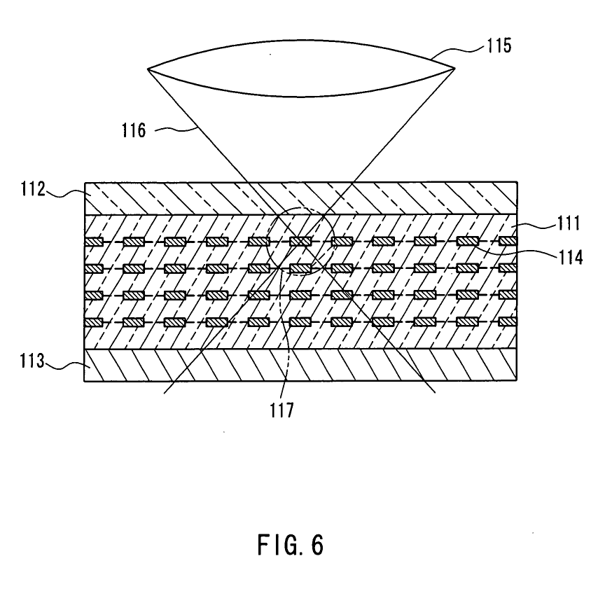

### BEST MODE FOR CARRYING OUT THE INVENTION

Embodiments of the present invention now will be described with reference to the drawings.

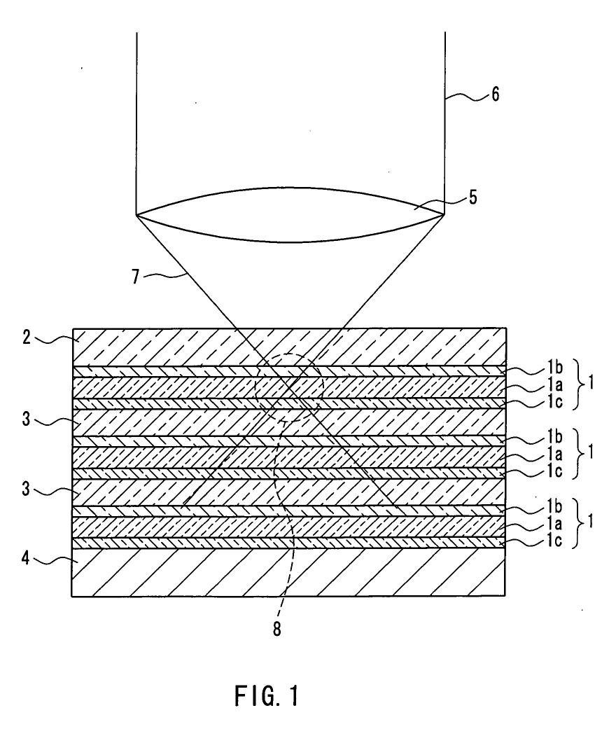

FIG. 1 is a cross section illustrating an embodiment of the optical information recording carrier of the present invention. The optical information recording carrier in this embodiment comprises three recording films 1 provided over a substrate 4, and a protective layer 2 further provided as the uppermost layer. Recording film separating layers 3 are provided between adjacent recording films 1. This optical information recording carrier is irradiated with light from the side where the protective layer 2 is provided, so an objective lens 5 for focusing light on the optical information recording carrier is disposed on the side of the protective layer 2 of the optical information recording carrier. The recording films 1 in this embodiment each comprise a heat-generating layer 1a, a first dielectric layer 1b disposed on the objective lens side with respect to the heat-generating layer 1a, and a second dielectric layer 1c disposed on the opposite side from the objective lens with respect to the heat-generating layer 1a. The first dielectric layer 1b and the second dielectric layer 1c are each provided in contact with the heat-generating layer 1a. In the drawing, 6 is a beam of parallel light, 7 is focused light produced by the objective lens 5, and 8 is the focal area of the focused light 7.

The heat-generating layer 1a is substantially transparent with respect to light of the wavelength λ used for the recording light, and when irradiated with recording light at a predetermined electrical field intensity, absorbs this recording light and generates heat through multiple photon absorption. Specifically, the heat-generating layer 1a is formed from a material with high sensitivity as a multiple photon absorption material, preferably a material whose refractive index has as large a tertiary nonlinear coefficient as possible, such as a material containing tellurium oxide, lithium niobate, zinc oxide, titanium oxide, bismuth oxide, or the like.

The first dielectric layer 1b and the second dielectric layer 1c are substantially transparent with respect to light of the wavelength λ used for the recording light, and signal portions are formed by heat transmitted from the heat-generating layer 1a. For example, when signal portions are formed by thermal deformation, a thermoplastic material can be used for the first dielectric layer 1b and the second dielectric layer 1c, in which case styrene or the like can be used to advantage. When signal portions are formed by utilizing the strain produced by the difference relative to the coefficient of thermal expansion of the heat-generating layer 1a, the first dielectric layer 1b and the second dielectric layer 1c may be formed, for example, by using silicon dioxide, magnesium fluoride, calcium fluoride, indium oxide, tin oxide, or the like. Examples of signal portions produced using strain include cracks and partial separations produced by a shift at the interface with the heat-generating layer 1a.

The substrate 4 can be formed from polycarbonate, for example. The protective layer 2 and the recording film separating layers 3 can be formed from a resin material or the like that is substantially transparent to the recording light, such as a UV-curing resin, or it may be formed by bonding PMMA (polymethyl methacrylate) thin sheets with a UV-curing resin.

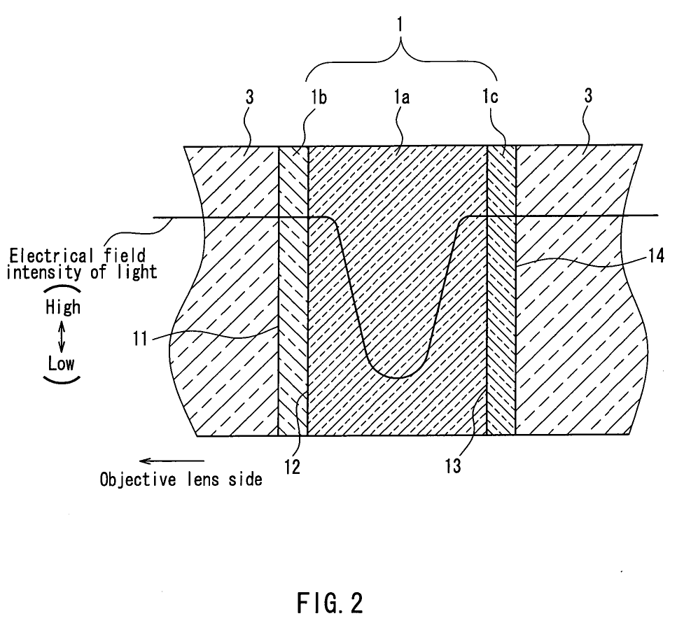

A case in which the recording films 1 of this optical information recording carrier are irradiated with the focused light 7 now will be described in specific terms through reference to FIG. 2. For ease of description, the example here will be of a case in which the refractive indices of the first dielectric layer 1b and the second dielectric layer 1c are substantially equal to the refractive index of the recording film separating layers 3. When a UV-curing resin is used for the recording film separating layers 3, and silicon dioxide films formed by vapor deposition are used as the first and second dielectric layers 1b and 1c, the refractive indices of both can be adjusted around 1.5, so a structure such as this can be realized with ease. Also, when tellurium oxide is used as the material constituting the heat-generating layer 1a, the refractive index thereof will be approximately 2.2. In view of this, we will consider here a case in which the refractive index of the first dielectric layer 1b and the second dielectric layer 1c and the refractive index of the recording film separating layers 3 are approximately 1.5, and the refractive index of the heat-generating layer 1a is approximately 2.2.

FIG. 2 is an enlarged cross section of an example of the recording film 1 that is located in the middle out of the three recording films 1 provided for the optical information recording carrier shown in FIG. 1. FIG. 2 also shows the distribution of electrical field intensity of light when this recording film 1 is irradiated with the focused light 7 produced by the objective lens 5. The actual electrical field intensity of light can be obtained by considering the merging of light reflected at the various interfaces with the irradiating focused light 7 with this film structure. In the drawing, 11 is the interface between a recording film separating layer 3 and the first dielectric layer 1b, 12 is the interface between the first dielectric layer 1b and the heat-generating layer 1a, 13 is the interface between heat-generating layer 1a and the second dielectric layer 1c, and 14 is the interface between the second dielectric layer 1c and another recording film separating layer 3. In this example, because the refractive indices of the recording film separating layers 3 and the first and second dielectric layers 1b and 1c are substantially the same, there is no need to take into account the light reflected at the interfaces 11 and 14, and only the light reflected at the interfaces 12 and 13 needs to be considered.

First let us consider the interface 13. Since the refractive index of the heat-generating layer 1a is 2.2 and the refractive index of the second dielectric layer 1c is 1.5, the light reflected at this interface 13 has a form such that the incident light waveplane is bent back at the interface 13.

Let us next consider the interface 12. When recording light is incident from the first dielectric layer 1b (refractive index of 1.5) on the heat-generating layer 1a (refractive index of 2.2), the phase of the reflected light generated at the interface 12 becomes a phase (antiphase) that is delayed (or advanced) by 180 degrees with respect to the incident light. When λ1 is the wavelength of the recording light within the heat-generating layer 1a, then if the thickness of the heat-generating layer 1a is λ1/2, the reflected light from the interface 12 and the reflected light from the interface 13 will cancel each other out completely within the recording film separating layers 3.

To describe this in more detail, in a positional relationship of light in which light reflected at the interface 13 is viewed from the interface 12, there is reflected light that merely returns in the direction of the light source after being shifted by one round-trip of λ1/2, or one wavelength. Apart from this, since antiphase reflection occurs at the interface 12 as discussed above, the reflected light is antiphase, and these two types of reflected light cancel each other out within the recording film separating layers 3.

Also, the amplitudes of the two types of reflected light here are equal to each other because they are both proportional to the difference between the refractive index of the silicon dioxide that makes up the first and second dielectric layers 1b and 1c and the refractive index of the tellurium oxide that makes up the heat-generating layer 1a. Therefore, within the recording film separating layers 3, these two types of reflected light cancel each other out. Meanwhile, within the heat-generating layer 1a, the waveplane of the incident light and the waveplane of the light reflected at the interface 13 enter a canceling phase at a location of λ1/4 away from the interface 12.

For the above reasons, the electrical field intensity of light at the interfaces 12 and 13 between the heat-generating layer 1a and the first and second dielectric layers 1b and 1c can be raised to its maximum by setting the thickness of the heat-generating layer 1a to an integer (n1) multiple of λ1/2. Also, since the light reflected at the interface 12 and the light reflected at the interface 13 cancel each other out, there is no reflected light from this recording film 1 when irradiating recording light. Because of this, all of the power of the recording light is consumed in the recording film 1, so heat is generated efficiently by the heat-generating layer 1a near the interfaces 12 and 13 where the electrical field intensity of the light is at its maximum. The heat thus generated is transmitted to the first and second dielectric layers 1b and 1c that are in contact, forming signal portions through the utilization of partial separation or cracking produced by the strain arising from the difference in the coefficients of thermal expansion between the heat-generating layer 1a and the first and second dielectric layers 1b and 1c.

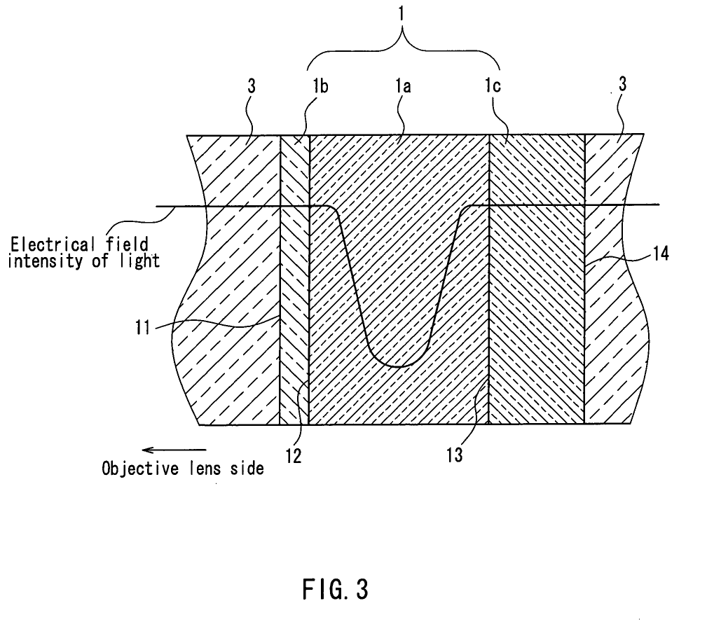

The example described for the structure shown in FIG. 2 was one in which dielectric layers of the same thickness were disposed on both sides of the heat-generating layer 1a, but as shown in FIG. 3, the structure also may be one in which the first dielectric layer 1b is thinner and the second dielectric layer 1c is thicker.

In the example shown in FIG. 3, equal amounts of heat are generated at the interfaces 12 and 13, but since the second dielectric layer 1c is thicker than the first dielectric layer 1b, sensitivity will be poor and almost no information will be recorded (no signal portions will be formed) even if heat is added in the second dielectric layer 1c.

Therefore, if the second dielectric layer 1c is made thicker than the first dielectric layer 1b, as shown in FIG. 3, only the first dielectric layer 1b will function as a portion where signal portions are formed. Accordingly, signal recording quality will be better than with the film structure shown in FIG. 2.

A case in which there is a difference in the refractive indices of the recording film separating layers 3 and the first and second dielectric layers 1b and 1c now will be described.

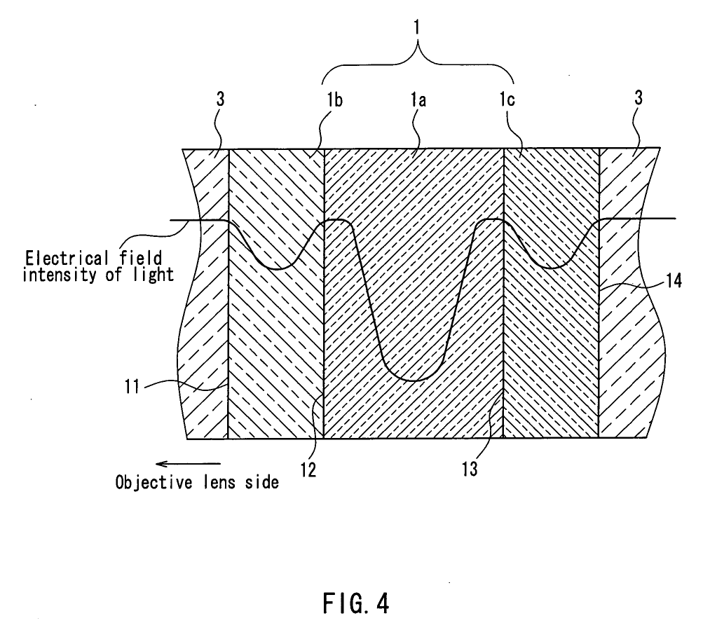

FIG. 4 shows the distribution of electrical field intensity of light in this film structure. In this case, reflected light produced by a refractive index differential is generated at the interface 11 between a recording film separating layer 3 and the first dielectric layer 1b, and the interface 14 between the second dielectric layer 1c and another recording film separating layer 3.

If we let λ2 be the wavelength of the recording light within the first and second dielectric layers 1b and 1c, the reflected light produced at the interface 14 is added together at the interfaces 12 and 13 when the thickness of the second dielectric layer 1c is λ2/2 and the thickness of the first dielectric layer 1b is λ2/2, so the electrical field intensity of the light reaches its maximum at the interfaces 12 and 13. Also, because the reflected light produced at the interface 11 cancels out the reflected light produced at the interface 14, there is no reflected recording light within the recording film separating layers 3 in this case, either. Therefore, the electrical field intensity of the light can be set to its maximum at the interfaces 12 and 13 between the heat-generating layer 1a and the first and second dielectric layers 1b and 1c by setting the thickness of the first and second dielectric layers 1b and 1c to an integer (n2) multiple of λ2/2.

Therefore, none of the power of the recording light is wasted, with all of it being consumed in the recording film 1, so heat is generated efficiently at the interfaces 12 and 13 between the heat-generating layer 1a and the first and second dielectric layers 1b and 1c.

Here again, the first dielectric layer 1b and the second dielectric layer 1c do not need to have the same thickness, and the same effect will be obtained with integer multiples of λ2/2.

As described above, the recording films 1 each comprise the heat-generating layer 1a, which is formed from a material with high sensitivity as a multiple photon absorption material, and the dielectric layers 1b and 1c that are provided in contact with this heat-generating layer 1a, the result of which is that heat is generated efficiently at the interface between the heat-generating layer 1a and the dielectric layers 1b and 1c, and this heat can be utilized to deform the dielectric layers 1b and 1c and thereby form signal portions, so recording sensitivity is improved.

### EXAMPLES

The present invention will be described in more specific terms through examples.

### Example 1

The light source used for signal recording made use of the second harmonic wavelength of 532 nm of a YAG laser (1065 nm). The numerical aperture of the objective lens 5 used for converging the light from the light source onto the recording films of the optical information recording carrier was 0.8. The heat-generating layer 1a was formed by vapor deposition of tellurium dioxide, which is substantially transparent at the wavelength (532 nm) of the recording light and has a large two-photon absorption coefficient (is highly sensitive as a multiple photon absorption material). The thickness of the heat-generating layer 1a was set at 0.24 μm so as to correspond to one wavelength of the recording light within this film. The first dielectric layer 1b also was formed by vapor deposition, but from silicon dioxide. The thickness of the first dielectric layer 1b was set at 0.177 μm so as to correspond to one-half the wavelength of the recording light within this film. The second dielectric layer 1c was a slide glass with a thickness of 1 mm. The recording film separating layers 3 were produced by spin coating with a UV-curing resin (such as Daicure Clear™ made by Dainippon Ink & Chemicals). The rotational speed of the spin coating apparatus and the resin viscosity were adjusted so that the thickness of the recording film separating layers 3 would be 10 μm.

Signal recording was performed under the above optical conditions on the sample produced in this manner. As a result, good signal pits could be written near the interface 12 of the first dielectric layer 1b of this sample.

The signal pits were about 1 μm in size, and the power required for recording (recording power) was approximately 1 W as the peak power at an irradiation duration of 6 nsec. Thus, recording featuring two-photon absorption could be accomplished at a lower recording power than in the past. These results led to the conclusion that the signal write power can be reduced by optimizing such factors as the material, refractive index, and thickness of the heat-generating layer 1a and the first and second dielectric layers 1b and 1c that make up the recording films 1.

For the sake of comparison, comparative samples in which the recording films 1 were composed only of the heat-generating layer 1a (no dielectric layers provided) also were prepared. Two types were produced: a comparative sample in which the heat-generating layer 1a (which also served as the recording film) was formed from tellurium dioxide, and a comparative sample in which this layer was formed from silicon dioxide. The write sensitivity was measured for each of these comparative samples under the same optical conditions as for the samples of the working example.

In the comparative sample in which the heat-generating layer 1a was formed from tellurium dioxide, the thickness of the heat-generating layer 1a was set at 0.24 μm. The recording film separating layers 3 were formed by the same method and from the same material as in Example 1, and their thickness was set at 10 μm. When signal recording was performed with this comparative sample, the size of the signal pits was approximately 1 μm, and the recording power was approximately 250 W as the peak power at an irradiation duration of 6 nsec.

Meanwhile, with the comparative sample in which the heat-generating layer 1a was formed from silicon dioxide, the thickness of the heat-generating layer 1a was set at 0.177 μm. The recording film separating layers 3 were formed by the same method and from the same material as in Example 1, and their thickness was set at 10 μm. When signal recording was performed with this comparative sample, the size of the signal pits was approximately 1 μm, and the recording power was approximately 37.5 kW as the peak power at an irradiation duration of 6 nsec.

The above results confirmed that forming the recording films from a heat-generating layer and dielectric layers as in the present invention increases the multiple photon absorption recording sensitivity.

### Example 2

In this example, tungsten oxide was added to tellurium dioxide, and the heat-generating layer 1a was produced by two-element vapor deposition (80 wt % tellurium dioxide, 20 wt % tungsten oxide). A GaN semiconductor laser (oscillation wavelength of 405 nm) was used as the signal recording light source. The thickness of the heat-generating layer 1a was set at 0.2 μm so as to correspond to one wavelength of the incident light within this film. The first dielectric layer 1b and the second dielectric layer 1c were produced by sputtering silicon dioxide. The thickness of the first dielectric layer 1b and second dielectric layer 1c was set at 0.16 μm so as to correspond to one-half the wavelength of the incident light within these films. The recording film separating layers 3 were formed by the same method and from the same material as in Example 1, and their thickness was set at 10 μm.

A sample was produced by laminating 20 of the recording films 1 produced as above, with recording film separating layers 3 in between. This sample was used in signal recording using a GaN semiconductor laser (oscillation wavelength of 405 nm) as the light source, and using an objective lens 5 with a numerical aperture of 0.85.

The power required to record signals onto the recording films of this sample was examined and found to be 100 mW at an irradiation duration of 6 nsec. It was confirmed that good writing can be performed at this recording power with any of the recording films included in this sample (any of the 20 layers).

The optical power then was reduced to 50 mW, and the sample was checked to see if the recorded signals could be read. As a result, a good reproduction signal (C/N ratio of approximately 50 dB) was obtained.

As discussed above, with the optical information recording carrier of the present invention, the sensitivity of multiple photon absorption recording can be raised over that attained in the past, which makes it possible to switch the light source used in multiple photon absorption recording from a large high-power laser to a smaller semiconductor laser.

### INDUSTRIAL APPLICABILITY

The optical information recording carrier of the present invention allows sensitivity in multiple photon absorption recording to be raised over that attained with conventional recording carriers, and therefore can be applied as a recording medium for multiple photon absorption recording when it is impossible to use a large high-power light source, for instance.

1. An optical information recording carrier comprising a substrate and at least one recording film provided over the substrate, with which information is recorded on the recording film by irradiation with recording light having a predetermined wavelength λ,
wherein the recording film comprises a heat-generating layer and at least one dielectric layer provided in contact with the heat-generating layer, and
the heat-generating layer and the dielectric layer are substantially transparent with respect to light of the wavelength λ, and have a predetermined thickness and a predetermined refractive index with which the electrical field intensity of the recording light is at its maximum at an interface between the heat-generating layer and the dielectric layer.

2. The optical information recording carrier according to claim 1, wherein the dielectric layer is provided in contact with the heat-generating layer on both sides of the heat-generating layer.

3. The optical information recording carrier according to claim 1, wherein, if λ1 is the wavelength of the recording light within the heat-generating layer, the thickness of the heat-generating layer is (n1×1)/2, where n1 is an integer of at least 1.

4. The optical information recording carrier according to claim 1, wherein, if λ2 is the wavelength of the recording light within the dielectric layer, the thickness of the dielectric layer is (n2×λ2)/2, where n2 is an integer of at least 1.

5. The optical information recording carrier according to claim 1, wherein a plurality of said recording films are provided, and a recording film separating layer that is substantially transparent with respect to light of the wavelength λ is disposed between adjacent recording films.

6. The optical information recording carrier according to claim 1, wherein the heat-generating layer contains at least one compound selected from among tellurium oxide, lithium niobate, zinc oxide, titanium oxide, and bismuth oxide.

7. The optical information recording carrier according to claim 1, wherein the dielectric layer is formed from a resin.

8. The optical information recording carrier according to claim 1, wherein the dielectric layer contains at least one compound selected from among silicon dioxide, magnesium fluoride, calcium fluoride, indium oxide, and tin oxide.

9. The optical information recording carrier according to claim 1, wherein the dielectric layer is formed from a thermoplastic material.

10. The optical information recording carrier according to claim 1, wherein the heat-generating layer generates heat by absorbing multiple photons near its interface with the dielectric layer.

11. The optical information recording carrier according to claim 1, wherein the heat-generating layer and the dielectric layer have mutually different coefficients of thermal expansion.
